(19) United States
(12) Patent Application Publication
(10) Pub. No.: US 2026/0183957 A1
(43) Pub. Date: Jul. 2, 2026

(54) METHOD FOR DYNAMIC MEDIA CONTROL

(71) Applicant: Heather Hender, Portland, OR (US)

(72) Inventor: Heather Hender, Portland, OR (US)

(21) Appl. No.: 19/380,557

(22) Filed: Nov. 5, 2025

(51) Int. Cl. B25J 9/16; B65H 5/06

(52) U.S. Cl. CPC B25J 9/1682; B65H 5/062

(57) ABSTRACT

The invention is a method to dynamically control media webs by placing a dynamic control system between two fixed rollers. The dynamic control system comprises poly-axis robots coupled to a roller, and the robots dynamically adjust the roller's pivot rotation in the XYZ location. The dynamic control system further comprises web-edge and web-tension sensors. The control system further includes a system controller. The robots, edge, and tension sensors are communicatively coupled to the system controller, monitoring the web's position and tension, and relaying this information to the system controller. The system controller calculates the necessary adjustments to maintain the media web's ideal position and tension. The robots dynamically adjust the roller's position and pivot rotation in response to the system controller's instructions. A continuous feedback loop is formed, and the robots make real-time position and tension corrections.

### BACKGROUND

The present disclosure relates generally to media tracking and sheet weave reduction. Industrial processes often face challenges with media tracking and sheet weave reduction. The invention uses poly-axis robotics to dynamically adjust roller pivot rotation and, in the XYZ plane, location, direction, or coordinates for precise web alignment.

Current methods include lateral roller motion, offset pivot rollers, steering/pivot guided rollers, and wind/unwind guides. The present art uses fully automated feedback systems with automatic motion control for web alignment and tension adjustment. However, the present art does not utilize poly-axis robots for web alignment or to adjust tension. The invention disclosed herein utilizes poly-axis robots to control web alignment and adjust tension. Additionally, the robots have a smaller footprint. The use of poly-axis robots and the smaller footprint collectively provides an improvement over the present art.

### SUMMARY

The invention is a method for dynamically controlling media webs. The dynamic control system is located between two fixed rollers in a portion of a media web. The dynamic control system comprises poly-axis robots coupled to a roller, and the robots dynamically adjust the roller's pivot rotation in the XYZ location. The dynamic control system further comprises web edge and tension sensors. The control system further includes a system controller. The robots, edge, and tension sensors are communicatively coupled to the system controller, which monitors the web's position and tension and relays the information to the system controller. The system controller calculates the necessary adjustments to maintain the media web's ideal position and tension. The robots dynamically adjust the roller's position and pivot rotation in response to the system controller's instructions. A continuous feedback loop is formed, and the robots make real-time position and tension corrections.

### BRIEF DESCRIPTION OF THE DRAWINGS

FIG. 1 depicts a dual-polyaxis robot system with the robots coupled to each end of a dynamic roller.

FIG. 2 depicts a single-polyaxis robot, where one end is coupled to a dynamic roller and the other to a dynamic bearing.

FIG. 3 depicts a dual-polyaxis robot with a dynamic control system located between two fixed rollers in a portion of a media web.

### DETAILED DESCRIPTION

The disclosed method will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of the method are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Industrial processes often face challenges with media tracking and sheet weave reduction. The disclosed method uses poly-axis robotics to dynamically adjust roller pivot rotation and XYZ location for precise web alignment. By using poly-axis robots to replace current web-tracking systems, roller position is dynamically manipulated in the X, Y, and Z planes and pivoted for optimal alignment. Sensors are integrated into the system to provide feedback, driving adjustments that ensure precision and prevent over-tension. Non-limiting examples of sensors include force torque sensors/transducers, using one for each axis, or a multi-axis force torque sensor/transducer that can simultaneously monitor all three axes. The system is versatile, applicable across industries that rely on conveyor belt systems and media webs. This innovative approach combines robotics and control technology to address longstanding industrial challenges, offering a more efficient and adaptable solution.

Media misalignment and tracking errors in conveyor belt systems and media webs are reduced because the poly-axis robots dynamically adjust roller pivot rotation, and in the XYZ direction. Additionally, sensors provide real-time data, ensuring precise alignment and preventing media stress. In a first embodiment, two poly-axis robots are used to dynamically adjust roller positions. The robots work together to manipulate the roller in the XYZ planes and pivot it around a designated point or axis. In a second embodiment, one robot is coupled to one end of the roller, with a dynamic bearing on the other end. In either embodiment, the robots are equipped with and utilize tool center point (TCP) technology to control the roller's location and orientation precisely. The two-robot setup is the preferred embodiment because it provides the most enhanced and accurate control.

Additionally, web edge sensors monitor the web's position and relay this data to the system controller, and media tension sensors prevent over-tension or excessive media stress. Feedback from the robots is fine-tuned and dynamically adjusts the web system. A system controller is used for centralized control, processing sensor inputs, and determining the required XYZ and rotational adjustments. The controller interfaces with the robots to execute precise movements in real-time, ensuring optimal web alignment and tracking. The sensors detect the web's position and send data to the system controller. The controller calculates the necessary adjustments to maintain the web's ideal or center position. Then the robots dynamically adjust the roller's position and its pivot rotation according to the controller's instructions. A continuous feedback loop between sensors and robots ensures real-time corrections and prevents issues such as sheet weave or mis-tracking. Additional sensors or feedback mechanisms can be integrated to suit specific industrial needs.

In one embodiment, the media is a web or media web that is processed through a series of rollers, with non-limiting examples including paper, film, nonwoven, or newsprint. In a second embodiment, the media is a conveying system. Unlike a media web, conveying systems move objects from one location to another using a belt. Non-limiting examples of conveying systems include luggage or packages in a shipping facility or warehouse. As with a media web, the system controls belt tension and tracking.

### Definitions

The following definitions apply herein, unless otherwise indicated:
“Comprising,” “including,” and “having” (and conjugations thereof) are used interchangeably to mean including but not necessarily limited to, and are open-ended terms not intended to exclude additional elements or method steps not expressly recited.
Terms such as “first”, “second”, and “third” are used to distinguish or identify various members of a group, or the like, and are not intended to denote a serial, chronological, or numerical limitation.
“Coupled” means connected, either permanently or releasably, whether directly or indirectly through intervening components.
“Communicatively coupled” means that an electronic device exchanges information with another electronic device, either wirelessly or with a wire-based connector, whether directly or indirectly through a communication network.

### A Method for Dynamic Media Control

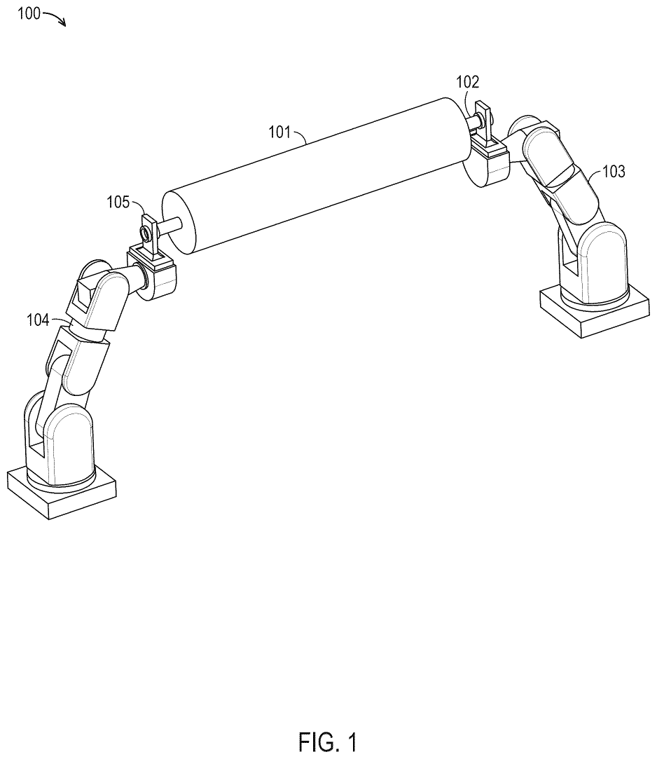

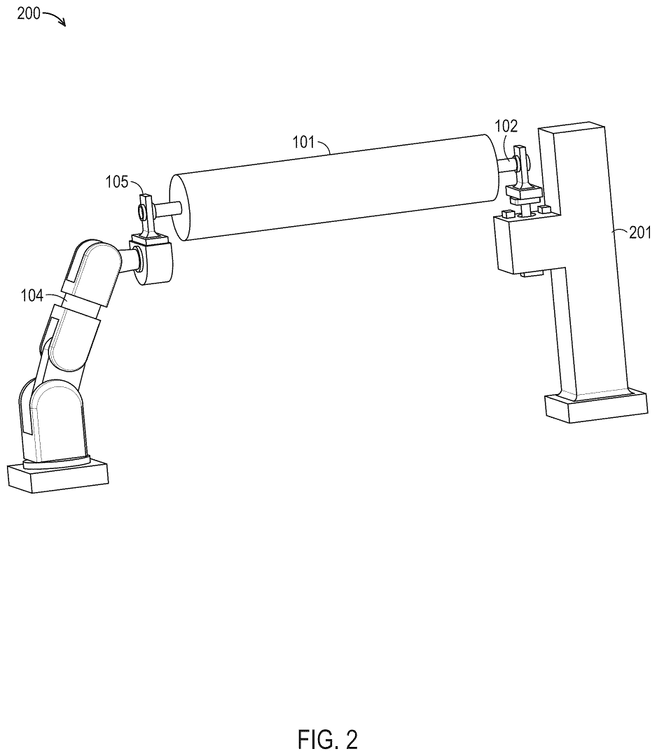

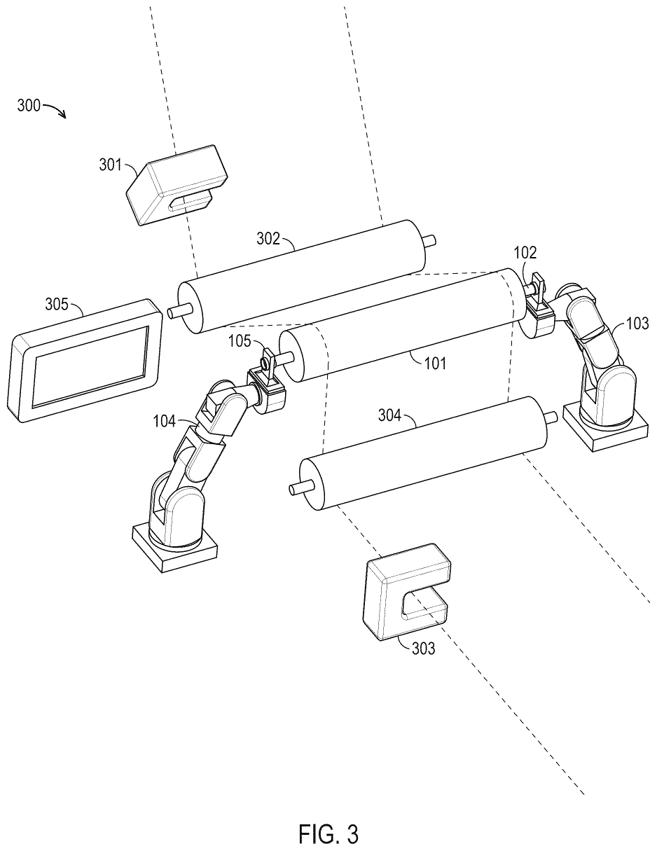

With reference to the FIGS. 1-3, a method for A DYNAMIC MEDIA CONTROL will now be described. FIG. 1 depicts a dual-polyaxis robot system 100 with the robots 103 and 104 coupled to the ends 102 and 105 of a dynamic roller 101. FIG. 2 depicts a single-polyaxis robot system 200, where the robot 103 is coupled to one end 105 of a dynamic roller 100 and the other end of the dynamic roller 105 is coupled to a dynamic bearing 201. FIG. 3 depicts a dual-polyaxis robot system 100 integrated into a media tracking system 300. The system comprises all the elements of a dual-axis robot system 100. Further, it comprises a first sensor 301, a second sensor 303, a first fixed roller 302, a second fixed roller 304, and a controller.

The disclosure above encompasses multiple distinct inventions with independent utility. While each of these inventions has been disclosed in a particular form, the specific embodiments disclosed and illustrated above are not to be considered in a limiting sense, as numerous variations are possible. The subject matter of the inventions includes all novel and non-obvious combinations and subcombinations of the various elements, features, functions, and/or properties disclosed above and inherent to those skilled in the art about such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements, and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

Having set forth the invention herein, I claim:

1. A method for the dynamic control of media webs comprising:
a. providing a media web, placing the media web under tension, a first fixed roller and a second fixed roller, where the dynamic control system is installed between the first fixed roller and the second fixed roller, and where the media web is in contact with the first fixed roller, the dynamic control system, and the second fixed roller; and
b. where the dynamic control system adjusts the roller's physical location and pivot rotation in XYZ coordinates.

2. Where the dynamic control system of claim 1 further comprises: at least one poly-axis robot and a roller with two ends, where the poly-axis robot is coupled to at least one end of the roller, and at least one of the robots dynamically adjusts the roller's physical location and pivot rotation in XYZ coordinates.

3. Where the dynamic control system of claim 1 further comprises: a roller having a first end and a second end, a first poly-axis robot and a second poly-axis robot, where the first poly-axis robot is coupled to the first end of the roller and the second poly-axis robot is coupled to the second end of the roller, and the robots work together to dynamically adjust the roller's physical location and pivot rotation in XYZ coordinates.

4. Where the dynamic control system of claim 1 further comprises: a roller having a first end and a second end, a poly-axis robot, and a dynamic bearing, where the poly-axis robot is coupled to the first end of the roller, and the second end of the roller is coupled to the dynamic bearing, and the robot dynamically adjusts the roller's physical location and pivot rotation in XYZ coordinates.

5. Where the dynamic control system of claim 3 further comprises:
a. at least one media web edge sensor, at least one media web tension sensor, and a system controller, where the media web edge sensor and the media web tension sensor are communicatively coupled to the controller and monitor the web's position and tension and relay information to the system controller;
b. where the poly-axis robots are communicatively coupled to the system controller and relay the XYZ positional data to the system controller;
c. where the system controller calculates the necessary adjustments to maintain the media web's ideal position; the robots dynamically adjust the roller's physical location and pivot rotation in XYZ coordinates; and
d. where a continuous feedback loop from the web edge sensor, media web tension sensor, and the robots provides real-time position and tension corrections.

6. Where the dynamic control system of claim 4 further comprises:
a. at least one media web edge sensor, at least one media web tension sensor, and a system controller, where the media web edge sensor and the media web tension sensor are communicatively coupled to the controller and monitor the web's position and tension and relay information to the system controller;
b. where the poly-axis robot is communicatively coupled to the system controller and relays the roller's physical location and XYZ positional data to the system controller; and
c. where the system controller calculates the necessary adjustments to maintain the media web's ideal position; the poly-axis robot dynamically adjusts the roller's physical location and pivot rotation in XYZ coordinates; and
d. where a continuous feedback loop from the web edge sensor, media web tension sensor, and the poly-axis robots make real-time position and tension corrections.

7. A method for the dynamic control of conveyor belts comprising:
a. providing a conveyor belt system, placing the conveyor belt under tension, a first fixed roller, and a second fixed roller, where the dynamic control system is installed between the first fixed roller and the second fixed roller, and where the conveyor belt is in contact with the first fixed roller, the dynamic control system, and the second fixed roller; and
b. where the dynamic control system adjusts the roller's physical location and pivot rotation in XYZ coordinates.

8. Where the dynamic control system of claim 7 further comprises: at least one poly-axis robot and a roller with two ends, where the poly-axis robot is coupled to at least one end of the roller, and at least one of the robots dynamically adjusts the roller's physical location and pivot rotation in XYZ coordinates.

9. Where the dynamic control system of claim 7 further comprises: a roller having a first end and a second end, a first poly-axis robot and a second poly-axis robot, where the first poly-axis robot is coupled to the first end of the roller and the second poly-axis robot is coupled to the second end of the roller, and the robots work together to dynamically adjust the roller's physical location and pivot rotation in XYZ coordinates.

10. Where the dynamic control system of claim 9 further comprises: a roller having a first end and a second end, a poly-axis robot, and a dynamic bearing, where the poly-axis robot is coupled to the first end of the roller, and the second end of the roller is coupled to the dynamic bearing, and the robot dynamically adjusts the roller's physical location and pivot rotation in XYZ coordinates.

11. Where the dynamic control system of claim 9 further comprises:
a. at least one conveyor belt edge sensor, at least one conveyor belt tension sensor, and a system controller, where the conveyor belt edge sensor and the conveyor belt tension sensor are communicatively coupled to the controller and monitor the conveyor belt's position and tension and relay information to the system controller;
b. where the poly-axis robots are communicatively coupled to the system controller and relay the roller's physical location and XYZ positional data to the system controller;
c. where the system controller calculates the necessary adjustments to maintain the conveyor belt's ideal position; the poly-axis robots dynamically adjust the roller's physical location and pivot rotation in XYZ coordinates; and
d. where a continuous feedback loop from the conveyor belt edge sensor, conveyor belt tension sensor, and the poly-axis robots provides real-time position and tension corrections.

12. Where the dynamic control system of claim 10 further comprises:
a. at least one conveyor belt edge sensor, at least one conveyor belt tension sensor, and a system controller, where the conveyor belt edge sensor and the conveyor belt tension sensor are communicatively coupled to the controller and monitor the conveyor belt's position and tension and relay information to the system controller; and
b. where the poly-axis robot is communicatively coupled to the system controller and relays the XYZ positional data to the system controller; and where the system controller calculates the necessary adjustments to maintain the conveyer belt's ideal position; the poly-axis robot dynamically adjusts the roller's physical location and pivot rotation in XYZ coordinates based on the system controller's instructions; and where a continuous feedback loop from the conveyer belt edge sensor, conveyer belt tension sensor, and the poly-axis robots make real-time position and tension corrections.
